(19) United States
(12) Patent Application Publication
(10) Pub. No.: US 2015/0277147 A1
(43) Pub. Date: Oct. 1, 2015

(54) THERAPEUTIC CONTACT LENS

(71) Applicant: Seonho KIM, (US)

(72) Inventor: Seonho Kim, Gwangju (KR)

(21) Appl. No.: 14/435,200

(22) PCT Filed: Oct. 29, 2013
(86) PCT No.: PCT/KR2013/009691

§ 371 Date: Apr. 13, 2015

(30) Foreign Application Priority Data
Oct. 30, 2012 (KR) 10-2012-0121406

(51) Int. Cl. G02C 7/04

(52) U.S. Cl. CPC G02C 7/04

(57) ABSTRACT

Disclosed is a therapeutic contact lens which is capable of receiving a treatment medicine between an eyeball and the lens, and thus enhancing an eye treatment effect and treatment speed.

The therapeutic contact lens according to the present invention includes a lens body having a spherical surface to be easily worn on an eyeball, a receiving part formed at an inner surface of the lens body in contact with the eyeball to be recessed outward, and a medicine part accommodated in the receiving part to transfer a medicine component to the eyeball, when the lens body is worn on the eyeball.

The receiving part may be formed at a center of the inner surface of the lens body to have a recessed circular groove shape having a predetermined diameter. Alternatively, a light transmission part may be formed at a center of the lens body so that a user secures a front sight, and the receiving part may be formed along an edge of the light transmission part to have a ring shape.

### CROSS-REFERENCE TO RELATED APPLICATION

This application claims priority to and the benefit of Korean Patent Application No. 2012-0121406, filed on Oct. 30, 2012, the disclosure of which is incorporated herein by reference in its entirety.

### BACKGROUND

1. Field of the Invention

The present invention relates to a therapeutic contact lens, and more particularly, to a therapeutic contact lens which is capable of receiving a treatment medicine between an eyeball and the lens, and thus enhancing an eye treatment effect and treatment speed.

2. Discussion of Related Art

Currently, the most commonly used medicine injection method for solving a problem such as various kinds of ocular diseases or corneal damages is to use eye drops or eye bath drops.

In the case of the eye drops or the eye bath drops, there is inconvenience in that the eye drops or the eye bath drops should be frequently injected to maintain a constant concentration which may keep a treatment effect, and there are also some problems in that the medicine may be washed away from an eyeball by eye blink motions, and thus a maintenance time of the effective treatment concentration is shortened, and also a low medicine concentration is remained for a long period of time, and thus the treatment effect is reduced.

Therefore, instead of the eye drops or the eye bath drops, ophthalmic salves as viscous semi-solid medicines are used widely. Since the salve type medicine has a relatively long contact time with the eyeball, compared with the eye drops, opportunity to absorb the medicine is increased. However, sight after the salve is applied is considerably reduced, and a user of the salve may feel uncomfortable due to feeling of irritation at the entire portion of the eyeball and around the eye caused by the salve.

To solve the problems, a development of a contact lens which accommodates a medicine has been performed. In Japanese Patent Publication No. 2012-511395, there is disclosed a medicine transferring device for a contact lens. A conventional contact lens includes a medicine releasing material containing a medicine. In the medicine transferring device for the contact lens, the contact lens is manufactured such that the medicine releasing material is inserted therein. Also, since the lens has a medicine eluting property, a medicine component is released from the medicine releasing material, and acts on the eyeball.

In the case of the conventional contact lens, since the contact lens should be formed in a state in which the medicine releasing material is inserted in the lens, a manufacturing cost of the contact lens should be increased. Also, since the medicine component should come out through the lens, the medicine may not be smoothly supplied, and it is difficult to increase a concentration of the medicine acting on the eyeball.

### SUMMARY OF THE INVENTION

The present invention is directed to a therapeutic contact lens having a medicine receiving part by which a medicine acting on a surface of an eyeball may be remained for a long period of time on the surface of the eyeball, and may be prevented from being washed away by tears or eye blink motions.

According to an aspect of the present invention, there is provided a therapeutic contact lens including a lens body having a spherical surface to be easily worn on an eyeball, a receiving part formed at an inner surface of the lens body in contact with the eyeball to be recessed outward, and a medicine part accommodated in the receiving part to transfer a medicine component to the eyeball, when the lens body is worn on the eyeball.

The receiving part may be formed at a center of the inner surface of the lens body to have a recessed groove shape having a predetermined diameter, and a light transmission part may be formed at a center of the lens body so that a user secures a front sight, and the receiving part may be formed along an edge of the light transmission part to have a ring shape.

A medicine discharging hole may be formed to extend from an inner surface of the receiving part to an outer surface of the lens body, such that the medicine component of the medicine part accommodated in the receiving part is discharged to an outside of the lens body.

The medicine part may include a medicine sheet containing the medicine component or an amnion containing the medicine component.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view illustrating an example in which a therapeutic contact lens in accordance with a first embodiment of the present invention is worn on an eyeball;

FIG. 2 is a cross-sectional view illustrating a state in which the therapeutic contact lens of FIG. 1 is worn on the eyeball;

FIG. 3 is a partly cut-away perspective view of the therapeutic contact lens of FIG. 1;

FIG. 4 is a perspective view illustrating a therapeutic contact lens in accordance with a second embodiment of the present invention;

FIG. 5 is a cross-sectional view of the therapeutic contact lens of FIG. 4;

FIG. 6 is a perspective view illustrating a therapeutic contact lens in accordance with a third embodiment of the present invention;

FIG. 7 is a cross-sectional view of the therapeutic contact lens of FIG. 6;

FIG. 8 is a perspective view illustrating a therapeutic contact lens in accordance with a fourth embodiment of the present invention; and

FIG. 9 is a perspective view illustrating a therapeutic contact lens in accordance with a fifth embodiment of the present invention.

### DETAILED DESCRIPTION OF EXEMPLARY EMBODIMENTS

Hereinafter, a therapeutic contact lens in accordance with the present invention will be described in detail with reference to the accompanying drawings.

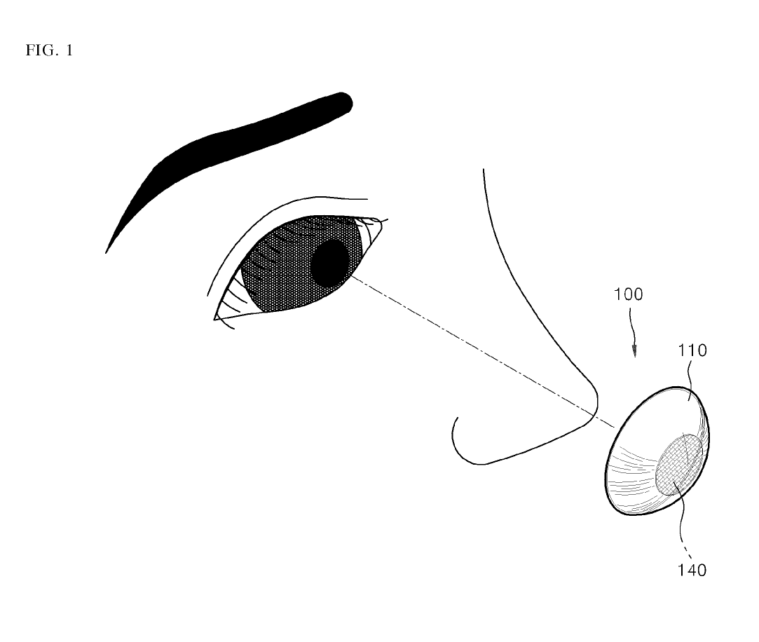

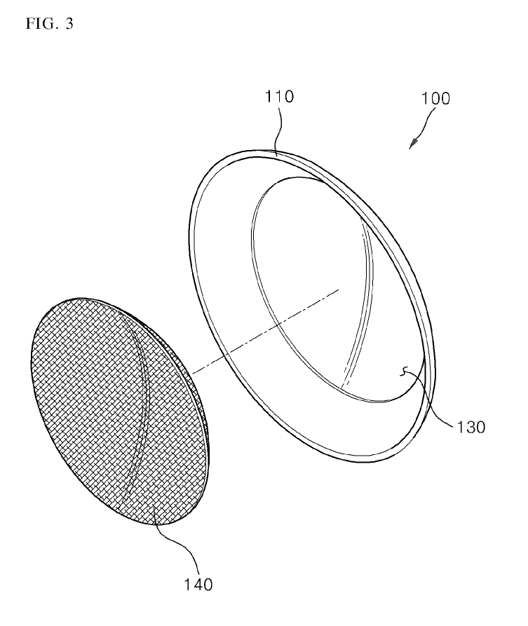

FIGS. 1 to 3 illustrate a therapeutic contact lens 100 in accordance with a first embodiment of the present invention. Referring to the drawings, like a general contact lens, the therapeutic contact lens 100 may be directly worn on an eyeball, as illustrated in FIG. 1, and may perform a medicine treatment of a medicine part 140 with respect to various kinds of ocular diseases or lesions such as a corneal damage.

The therapeutic contact lens 100 includes a lens body 110 which is formed in a spherical shape to be worn on the eyeball, a receiving part 130 which is formed at the lens body 110 to accommodate a medicine, and the medicine part 140 which is installed at the receiving part 130.

The lens body 110 is formed in the spherical shape which may be worn on the eyeball, like the general contact lens.

The receiving part 130 is formed at an inner surface of the lens body 110. The inner surface of the lens body 110 is a portion which is directly in contact with the eyeball, and the receiving part 130 is formed at one side of the inner surface of the lens body 110 in a recessed groove shape which is recessed outward by a predetermined depth.

The receiving part 130 serves to provide a receiving space in which the medicine part 140 is accommodated. In the embodiment, the receiving part 130 is formed at a center of an inner side of the lens body 110 in a circular groove shape having a predetermined diameter.

The depth and the diameter of the receiving part 130 may be variously set according to a kind or a shape of the medicine part 140 received in the receiving part 130.

The medicine part 140 may be accommodated in the receiving part 130 and worn on the eyeball to provide a medicine component to the eyeball, and may be formed in a salve or gel shape, or a sheet shape containing the medicine component. Alternatively, the medicine part 140 may be a material containing a treatment component such as a stem cell or an amnion which is a biological tissue.

In the embodiment, the medicine part 140 is formed in a medicine sheet containing the medicine component. The medicine sheet is accommodated in the receiving part 130, and then the lens body 110 is worn on the eyeball.

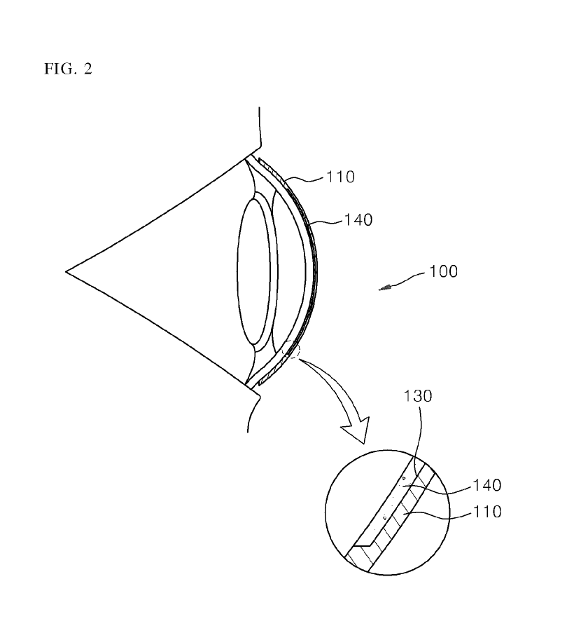

As illustrated in FIG. 2, in the therapeutic contact lens 100 having the above-described structure, the medicine sheet is directly in contact with the eyeball, and thus the medicine component directly acts on the eyeball. The medicine component may be prevented from being washed away due to eye blink motions. A constant concentration may be continuously maintained with a low concentration medicine. Also, when the therapeutic contact lens 100 is used to treat a damaged cornea, the lens body 110 may serve to protect a damaged portion, and also the medicine component may be remained for a long period of time on the damaged portion, and may be directly transferred to the damaged portion, thereby maximizing a treatment effect.

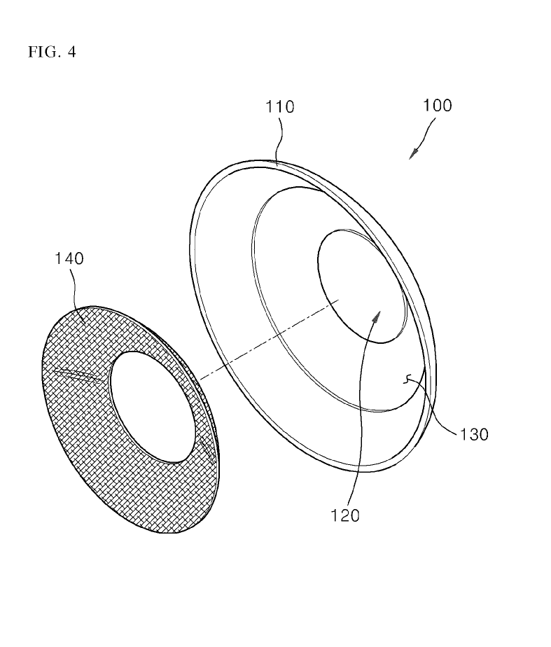

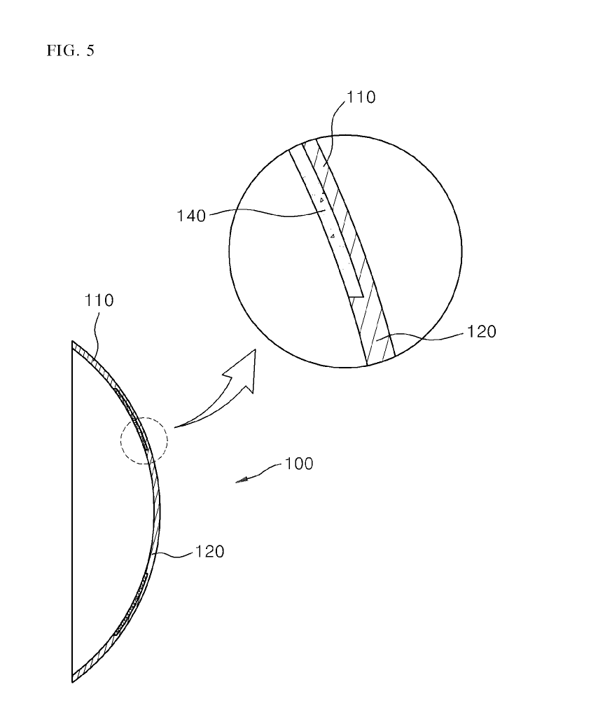

FIGS. 4 and 5 illustrate a therapeutic contact lens 100 in accordance with a second embodiment of the present invention.

The therapeutic contact lens 100 in accordance with the embodiment also includes the lens body 110, the receiving part 130 which is formed at the lens body 110, and the medicine part 140 which is installed at the receiving part 130.

The lens body 110 of the embodiment has a light transmission part 120 formed at a center thereof, and thus even when the lens body 110 is worn, a user may secure a better sight through the light transmission part 120. The receiving part 130 may be formed in a circular ring shape surrounding the light transmission part 120 and centering on the light transmission part 120, and may be formed in the recessed groove shape which is recessed toward an outer surface thereof, like the previous embodiment.

In the case of the embodiment, the medicine part 140 may be formed in the salve or gel shape and filled in the receiving part 130, and then the lens body 110 may be worn on the eyeball. Alternatively, the medicine part 140 may be formed in the ring-shaped medicine sheet corresponding to a shape of the receiving part 130 and filled in the receiving part 130, and may be worn on the eyeball.

Even in the case of the first embodiment, if the medicine sheet accommodated in the receiving part 130 is formed to be thin or transparent, it is possible to secure a certain degree of the sight. However, when the medicine sheet accommodated in the receiving part 130 is formed to be slightly thick or an opaque medicine is used, it is difficult to secure the sight. Therefore, in the case of the embodiment, the light transmission part 120 is formed at the center. Therefore, the therapeutic contact lens 100 in accordance with the embodiment may secure the front sight through the light transmission part 120, the user may go about his/her daily life, while wearing the lens. Also, in the embodiment, the medicine may be selectively transferred to a limbal area.

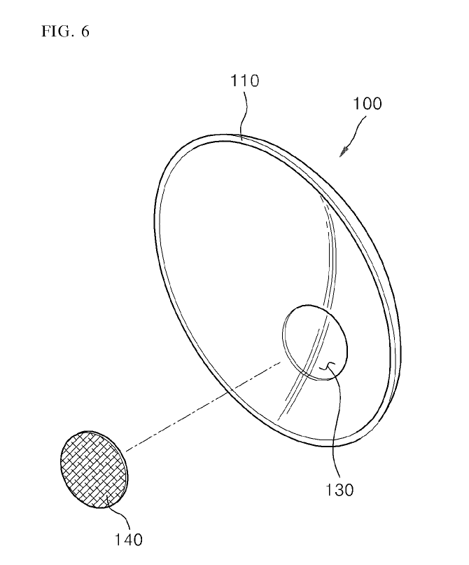

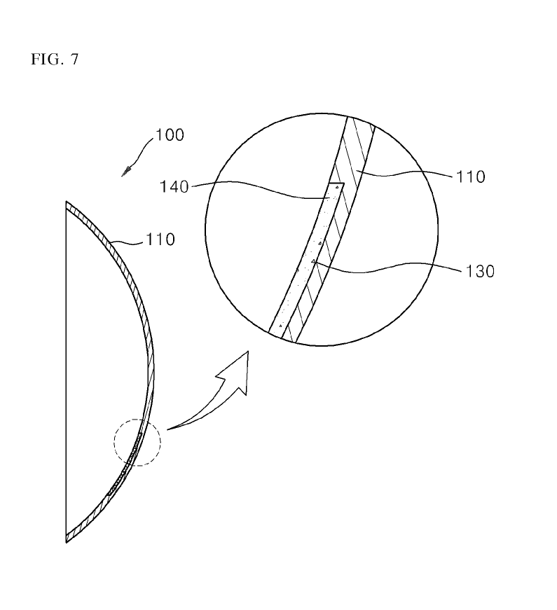

Also, in the therapeutic contact lens 100, as illustrated in FIGS. 6 and 7, the receiving part 130 may be formed at one side of the inner surface of the lens body 110 to have a predetermined shape. That is, when the medicine may be in contact with only a local area of the surface of the eyeball, the recessed groove having a predetermined diameter may be formed at a position, which is spaced a predetermined distance from the center of the lens body, so as to form the receiving part 130, like the embodiment, and the medicine may be injected into the receiving part 130, or the medicine sheet may be installed in the receiving part 130, and then the lens may be worn on the eyeball.

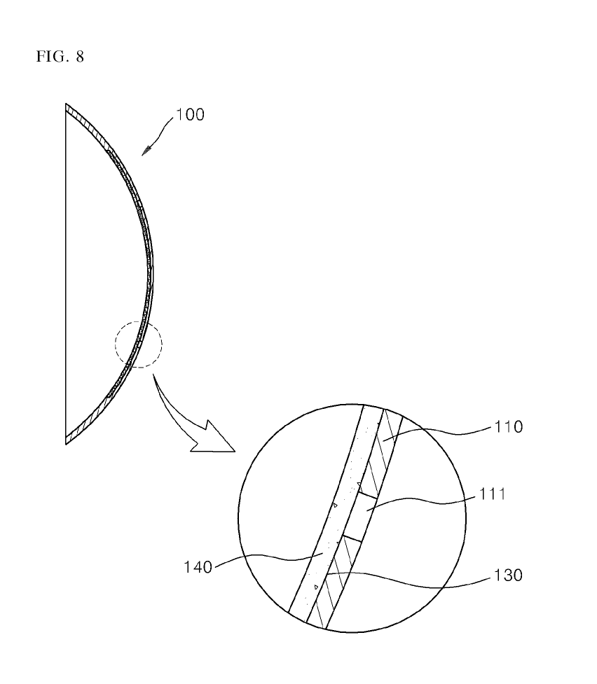

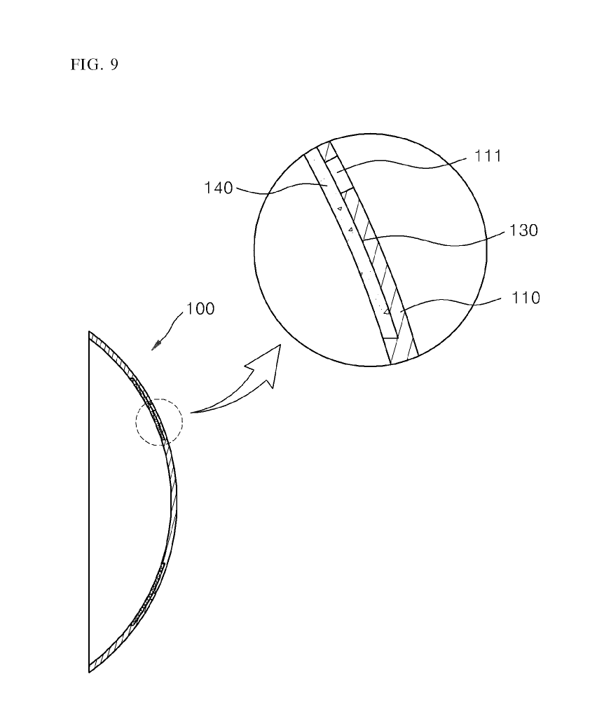

FIGS. 8 and 9 illustrate therapeutic contact lenses 100 in accordance with fourth and fifth embodiments of the present invention, respectively.

The therapeutic contact lens 100 in accordance with the fourth embodiment of the present invention illustrated in FIG. 8 has a similar structure to that of the first embodiment, in which the medicine sheet may be built in the center of the lens body 110. The therapeutic contact lens 100 in accordance with the fifth embodiment of the present invention illustrated in FIG. 9 has a similar structure to that of the second embodiment, in which the light transmission part 120 is formed at the center of the lens body 110, and the receiving part 130 is formed along an edge of the light transmission part 120.

In both of the therapeutic contact lenses 100 in accordance with the fourth and fifth embodiments of the present invention, a medicine discharging hole 111 is formed to extend from the receiving part 130 to an outer circumferential surface of the lens body 110.

The medicine discharging hole 111 serves to allow the medicine component of the medicine sheet to be supplied to an outside of the lens body 110, such that the medicine is supplied to a corresponding portion, when an infection or a lesion occurs at an inner side of an eyelid.

In the therapeutic contact lens 100 in accordance with the embodiment, since the medicine is discharged to an outside of the lens body 110 through the medicine discharging hole 111, the medicine may be supplied to the inner side of the eyelid, whenever eyes blink, and thus the treatment effect with respect to the lesion generated at the inner side of the eyelid may be increased.

The medicine discharging hole 111 formed at the lens body may have various sizes and shapes according to a kind or a supplied amount of the medicine, and the number of the medicine discharging holes 111 may be formed variously.

In the therapeutic contact lens 100 in accordance with the present invention as described above, since the medicine part 140 is directly in contact with the eyeball, the medicine component may be easily injected, and also since the medicine part 140 is accommodated in the receiving part 130, the medicine part 140 may be maintained in the contacted state with the eyeball, and thus may increase the treatment effect.

Since the therapeutic contact lens in accordance with the present invention has the receiving part in which the medicine is accommodated, it can be worn on the eyeball while the salve type medicine or the medicine sheet is received therein, and thus the medicine can be prevented from being washed away, and can be preferably maintained in the contacted state, thereby increasing the treatment effect.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A therapeutic contact lens comprising:
a lens body having a spherical surface to be easily worn on an eyeball;
a receiving part formed at an inner surface of the lens body in contact with the eyeball to be recessed outward; and
a medicine part accommodated in the receiving part to transfer a medicine component to the eyeball, when the lens body is worn on the eyeball.

2. The therapeutic contact lens of claim 1, wherein the receiving part is formed at a center of the inner surface of the lens body to have a recessed groove shape having a predetermined diameter.

3. The therapeutic contact lens of claim 1, wherein a light transmission part is formed at a center of the lens body so that a user secures a front sight, and the receiving part is formed along an edge of the light transmission part to have a ring shape.

4. The therapeutic contact lens of claim 3, wherein a medicine discharging hole is formed to extend from an inner surface of the receiving part to an outer surface of the lens body, such that the medicine component of the medicine part accommodated in the receiving part is discharged to an outside of the lens body.

5. The therapeutic contact lens of claim 3, wherein the medicine part is formed of a medicine sheet containing the medicine component.

6. The therapeutic contact lens of claim 3, wherein the medicine part comprises an amnion containing the medicine component.

7. The therapeutic contact lens of claim 1, wherein a medicine discharging hole is formed to extend from an inner surface of the receiving part to an outer surface of the lens body, such that the medicine component of the medicine part accommodated in the receiving part is discharged to an outside of the lens body.

8. The therapeutic contact lens of claim 1, wherein the medicine part is formed of a medicine sheet containing the medicine component.

9. The therapeutic contact lens of claim 1, wherein the medicine part comprises an amnion containing the medicine component.
